(19) United States
(12) Patent Application Publication
(10) Pub. No.: US 2009/0119956 A1
(43) Pub. Date: May 14, 2009

(54) FOLD-OUT ADVERTISING DISPLAY STAND

(76) Inventor: RAUL SANTIAGO MARTIN PRESA, Arganda Del Rey (ES)

Correspondence Address: William H. Honaker;Dickinson Wright PLLC, Ste. 2000, 38525 Woodward Ave, Bloomfield Hills, MI, 48304-2970, US

(21) Appl. No.: 11/937,621

(22) Filed: Nov. 9, 2007

(51) Int. Cl. G09F 11/00

(52) U.S. Cl. 40/1

(57) ABSTRACT

Advertising display stand comprising at least a body or module each of the bodies consisting of an advertising panel and an interior shaping panel which will permit the fold-out and automatic retention in folded out position without any need to use additional means for the automatic folding out and its subsequent retention, such as elastic or magnetic means, for which purpose the shaping panel is provided with curved edges, a central fold line divided into three zones by means of cuts which permit the definition of folding flaps in respect of a fold line, in such a way that the shaping panel when unfolded is convex along the fold line.

### OBJECT OF THE INVENTION

The present invention refers to a fold-out advertising display stand which is retained in a folded out position without the requirement for any additional means of retention.

The advertising display stand which is the object of this invention comprises an advertising panel arranged in such a way that its edges or ends are joined so that they define an interior space inside, to which adhere some cut shaping panels which permit automatic unfolding and retention.

The stand is particular in that it is able to remain folded, whereas when having folded-out the modules of which the display stand consists, and joined the ends or edges of the unit, the cut shaping panels arranged in its interior adopt a position which causes the advertising display surface to form an elliptical section, so that the lower edge serves as a support for the whole advertising display stand.

The present invention is characterised by the special configuration and design of all the panels which make up the advertising display stand, and in particular by the cut shaping panel arranged in the interior space defined by the information display panel support. As a result of the design of all the panels in the module, an advertising display stand is obtained which folds out and is automatically retained in position without any need to use additional means of retention such as magnetic or flexible means.

Therefore, the present invention is defined within the scope of fold-out advertising display stands, and in particular those which have no additional means for folding out and retaining them.

### BACKGROUND TO THE INVENTION

At present there are various fold-out advertising display stands equipped with flexible means for assisting their folding out such as the stand indicated in patent no. WO 2002095719.

These flexible means used for folding out the advertising display stands require the arrangement of interior wings or a frame consisting of flexible means for folding out. These flexible means remain elongated when the stand is folded, in such a way that when starting to fold out, the force of traction of the flexible means causes the advertising module to be folded out.

In general, these advertising display stands which use flexible means as a means for folding out have various disadvantages, on one hand, when the module is folded the flexible means need to be stressed, and on the other the flexible means used for correct fold-out are required to have specific dimensions, in addition, the flexible means need to be replaced after a certain period.

In addition the flexible means used in folding out the advertising display stands fold out the advertising display stand in a fixed manner, that is the degree of convexity of the advertising display surface is unique and fixed, and cannot be regulated.

Therefore, the object of the present invention, is to develop an advertising display stand which improves on the previous disadvantages, using as a means of folding out and retention the actual design of the interior cut shaping panel without the need to use additional means such as, for example, flexible means.

All the previous disadvantages have been overcome with the advertising display stand proposed in the present invention which bases its operation on the form, design, cuts and fold lines present in the interior cut shaping panel situated in the interior of the space defined by the panel which defines the surface of the support for the information to be displayed.

### DESCRIPTION OF THE INVENTION

The present invention of a foldout advertising display unit basically consists of an advertising panel on which the information to be displayed is laid out, with this panel having its edges joined throughout its length by means of a flap so that it defines a continuous surface.

The advertising display stand, like other stands, consists of a series of modules joined to each other by means of a fold line in such a way that that one module is folded on to the other.

In the interior space defined by the advertising panel, and in each of the modules of which it consists, a cut shaping panel adheres to its interior, which permits folding out and subsequent retention of the advertising display stand.

Folding out of the unit is obtained following the folding out or extension of the component modules and by exercising a slight pressure on their edges once the whole has been unfolded, and due to the configuration of the cut shaping panel and the form it takes, it is possible to maintain the entire support in fold-out position. In order to fold it is sufficient to exercise a slight pressure on the cut shaping panel so that it loses the position adopted.

The essential nature of the invention lies in the cut shaping panel and in particular in its form, cuts, fold lines etc.

Specifically, the edges of this panel which are in contact with the advertising display panel have a curvature which is equal to the curvature adopted by the stand when it is folded out. In addition this panel is fixed to the advertising panel by means of tabs emerging from its edges.

The shaping panel has a central longitudinal folding line which defines three separate parts made by cuts which define windows from which emerge flaps which are arranged in a manner perpendicular to the line of the longitudinal fold. The flaps also have a fold line so that in the advertising display stand folding position they can also be folded.

When the advertising display stand has been folded out the shaping panel takes on a convex surface so that the sections of the fold line arranged at the ends remain slightly pressed downwards, while the centre part of the panel in respect of its fold line is facing upwards in a convex manner, made possible as a result of the break in continuity of the longitudinal fold line of the shaping panel.

The break in continuity adopted by the fold line in the fold out position of the stand is achieved by cuts made in the shaping panel so that they form windows with flaps.

As a result of the characteristics of the shaping panel described it is possible to fold out the stand by exercising slight pressure on the edges of the advertising panel, and it is also possible to maintain it in this fold-out position without the requirement of any additional means either flexible, magnetic etc. the folding of the stand being achieved by exercising a slight pressure on the central part of the longitudinal fold line.

### DESCRIPTION OF THE DRAWINGS

In order to complete the description below and for the purpose of providing a greater understanding of the characteristics of the invention, a set of plans is attached to this descriptive report which, by way of illustration without being in any way restrictive, represent the most significant details of the invention.

In FIG. 1, in simplified form, an advertising display stand or pillar is shown comprising two bodies.

FIG. 2 shows the previous advertising display stand folded out, with the shaping panels adhering to the interior of each module.

FIG. 3 shows the same previously illustrated stand in semi-folded out form, showing the shape taken on by the interior shaping panel.

FIG. 4 shows an advertising display stand in the same semi-folded form as in FIG. 3 but indicating the two bodies which make up the advertising display stand.

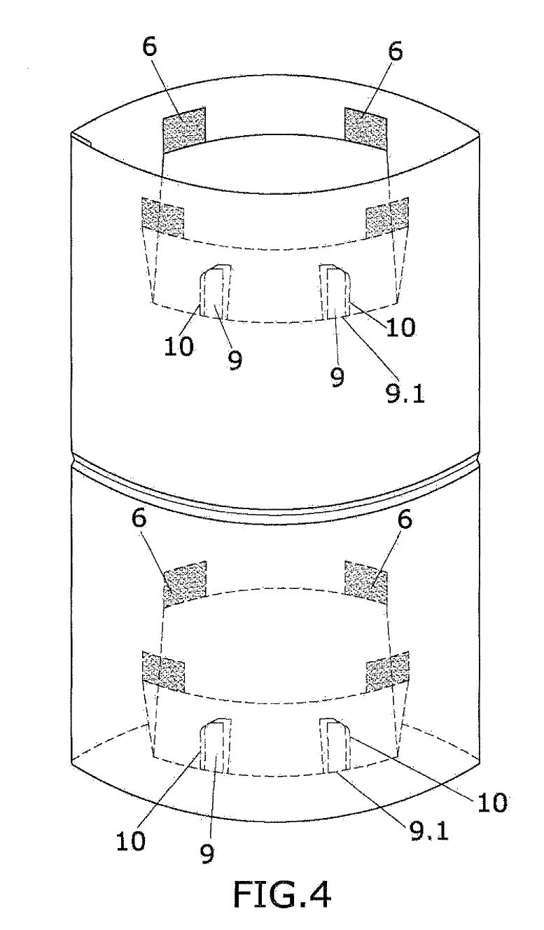

### PREFERRED EMBODIMENT OF THE INVENTION

In the light of these figures a preferred means of embodiment of the proposed invention is described below.

In FIG. 1 we note a folded out pillar or advertising display stand comprising two bodies or modules (1) joined by a fold line (2) which separates both modules. The number of bodies or modules (1) comprising the advertising display stand may vary, although logically there should be at least one body or module.

The advertising display stand comprising at least one body or module (1), comprises a single advertising panel, (3) on which the advertising to be displayed is placed, and closed on itself, that is, its free ends are joined by a flap (4) which connects the two free ends of the advertising panel.

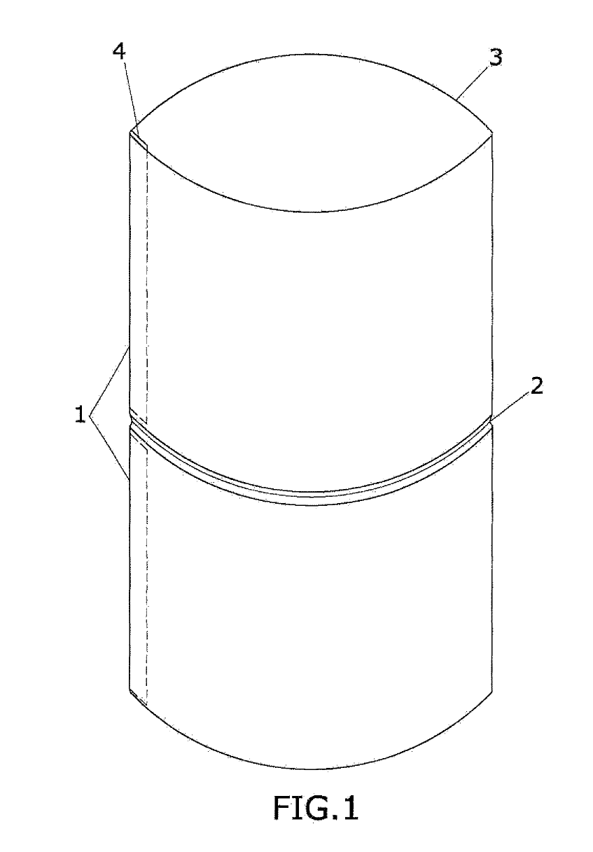

In FIG. 2 which shows the same advertising display stand the shaping panels have been added (5) comprising single cut panels fixed in the interior space defined by the advertising panel (39 when its free ends are closed.

The shaping panel (5) has curved edges (7) with the same curvature as that desired for the advertising display stand when it is folded out. Emerging from these edges attachment tabs protrude or emerge (6) which adhere to the interior face of the advertising panel (3).

The shaping panel (5) is divided into two parts (5.1) and (5.2) separated by a fold line(s) which runs longitudinally dividing the shaping panel into two equal parts (5).

Two cuts have been made (10) on the shaping panel (5) defining respective folding flaps (9), which are articulated with respect to a fold line (11). The transversal arrangement of the cuts (10) with respect to the fold line (8) of the shaping panel (5) divide the fold line (8) into three sections or zones, ie. two edges (8.2) and a section or central zone (8.1).

When the whole unit is completely folded out and retained in its folded out position, the shaping panel (5) has a general convex arrangement along the fold line, (8) however, the zone or part (8.2) of the fold line remains slightly depressed, whereas the central part or zone (8.1) of the fold line remains slightly convex, with the cuts producing the change from concavity to convexity, (10) which also causes the folding flaps (9) to remain slightly lifted when the display unit is folded out.

In addition, the folding flaps (9) for the purpose of proceeding to fold the unit have a fold down their middle (9.1) which permits folding of said flaps (8) down their middle as may be seen in FIG. 2.

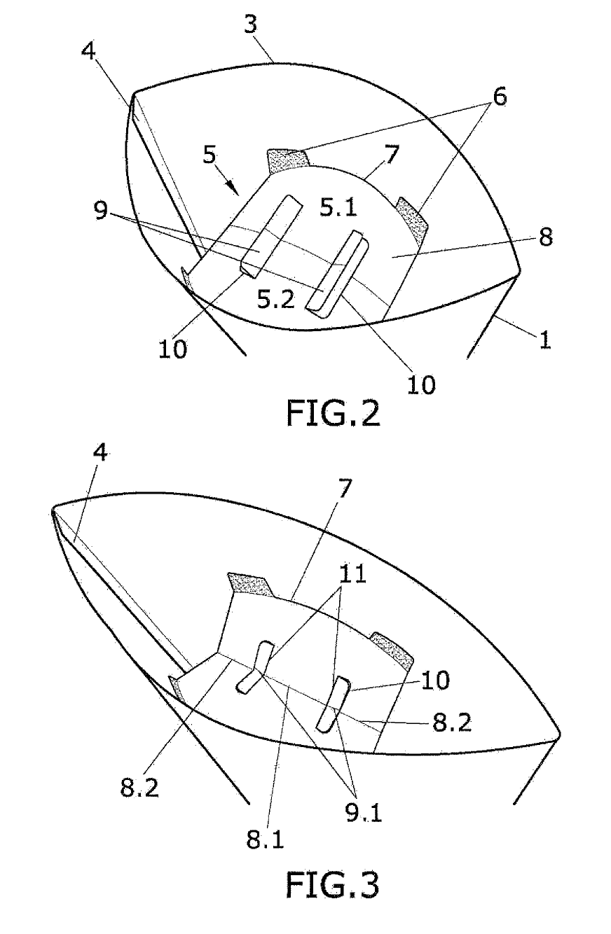

In FIG. 3 it is possible to observe the same advertising display unit when it is not folded out but slightly folded where the shaping panel folds along the fold line (8), folding both its end parts or zones (8.2) and the central fold part or zone (8.1) and the folding flaps also fold (9).

From a fold-out position as shown in FIG. 2 to a fold position as shown in FIG. 3, all that is required is a slight downward pressure against the convexity shown by the fold line (8) in its central part (8.1)

When the advertising display unit is placed as shown in FIG. 3, it is sufficient to bring the faces of the advertising panel (3) together in order to subsequently proceed to folding of each of the modules on themselves by means of the fold line (2).

Therefore, as a result of the unit described, the fold out of said unit is possible by applying slight pressure on the ends or points of the advertising display stand, and by means of the shaping panel described it folds out in such a way that it retains the unit in that position. Therefore, the shaping panel, among other characteristics, has curved edges with a curvature equal to that which it is desired for the advertising display unit to show when it is folded out, and which forms a convex surface in the direction of its longitudinal fold line.

The essential nature of this invention is not altered by variations in materials, form, size and arrangement of the component elements, which is described in a non-restrictive manner which is sufficient for it to be reproduced by an expert.

1. Fold-out advertising display stand which has at least one body or module (1) with an advertising panel (3) whose free ends are joined together by a flap (4) running along the joining edge of said free ends, and with a shaping panel (5) arranged in the interior space defined by the advertising panel (3), characterised in that the shaping panel is joined on one of its edges to the interior face of the advertising panel, with curved edges (7) and provided with a fold line (8) which runs from edge to edge and having some cuts (10).

2. Fold-out advertising display stand, according to claim 1, characterised in that the joining of the shaping panel to the advertising panel in its interior face is made by means of fixing tabs (6).

3. Fold-out advertising display stand, according to claim 1, characterised in that the curved edges (7) of the shaping panel, present a curvature equal to the curvature that it is desired that the advertising panel should have once the advertising display stand has folded out.

4. Fold-out advertising display stand according to claim 1, characterised in that the cuts (10) made on the shaping panel (5) permit the definition of folding flaps (9) which fold with respect to a fold line (11).

5. Fold out advertising display stand, according to claim 1, characterised in that the fold line (8) which runs from side to side of the shaping panel (5) is divided into two zones, that is two zones or end parts (8.2) and a central part or zone (8.1) which presents a different arrangement in folding, whereas the end parts or zones (8.2) are concave, the central zone or part (8.1) of the fold line (8) is convex.

6. Fold-out advertising display stand, according to claim 4, characterised in that the folding flaps (9) have a fold line in their middle (9.1) which will permit folding of the whole shaping panel (5) in half when the advertising display stand is folded.
